(19) United States
(12) Patent Application Publication
(10) Pub. No.: US 2017/0200356 A1
(43) Pub. Date: Jul. 13, 2017

(54) SURVEILLANCE CAMERA CAPABLE OF OUTPUTTING VIDEO AND VIDEO TRANSMISSION/RECEPTION SYSTEM INCLUDING SAME

(71) Applicant: San KIM, Seoul (KR)

(72) Inventor: San KIM, Seoul (KR)

(21) Appl. No.: 15/315,385

(22) PCT Filed: Jul. 4, 2014
(86) PCT No.: PCT/KR2014/005995

§ 371 Date: Dec. 1, 2016

(30) Foreign Application Priority Data
Jun. 11, 2014 (KR) 10-2014-0070692

(51) Int. Cl. G08B 13/196; H04N 5/232; H04L 29/06; H04N 7/18

(52) U.S. Cl. CPC G08B 13/19656; H04N 7/183; H04N 5/23293; H04N 5/23206; H04L 65/608

(57) ABSTRACT

Disclosed is a surveillance camera capable of outputting a video and a video transmission/reception system including the surveillance camera, the surveillance camera comprising: a communication unit for transmitting/receiving a network packet over the Internet network; a display unit for outputting a video generated on the basis of the received network packet; and a control unit for converting data of the network packet into video data to be output to the display unit.

### TECHNICAL FIELD

The present invention relates to a surveillance camera capable of outputting a video and a video transmission/reception system including the surveillance camera, and more specifically, to a surveillance camera capable of outputting a video and a video transmission/reception system including the surveillance camera, which can transmit a video and, in addition, sense an abnormal situation such as an intrusion from the outside and transmit and receive a video to and from the external apparatus.

### BACKGROUND ART

CCTVs (Closed Circuit TeleVision) are known to everybody. A CCTV is a system including a surveillance camera and a surveillance server and capable of transmitting an image captured by the surveillance camera to the surveillance server. The CCTV may be applied in a variety of fields such as industry, home, traffic monitoring, prevention of disaster and the like.

Meanwhile, as the fields in which the CCTVs can be applied are expanded, the CCTVs are widely used also at home. For example, the CCTVs are frequently used at home, in which infants, old people or pet animals live, to monitor the infants, the old people or the pet animals. In an existing home CCTV, parents or guardians at a remote site may monitor the infants, the old people or the pet animals and confirm an abnormal situation through a video using a cellular phone.

Meanwhile, from the standpoint of the infants, the old people or the like living at home, they need to be connected to parents or sons and daughters who can connect to the CCTV and see the parents or sons and daughters for psychological stability, frequent contact or the like. That is, bidirectional transmission and reception of a video, not unidirectional reception of a video, is needed. If a camera is capable of bidirectionally transmitting and receiving a video, infants at home may confirm the parents and have psychological stability, and the parents may frequently contact with their children.

An existing surveillance camera transmits only a video of an analog or digital signal to a surveillance server, and if the surveillance camera is installed inside a home and provided with a variety of additional functions, it may provide various beneficial advantages. For example, when a surveillance camera is installed inside a home, it needs to automatically confirm intrusion from the outside, an abnormal situation of a monitoring target or the like and transmit the situation to the surveillance server or the like.

Furthermore, there are some more things to consider for bidirectional transmission and reception of a video. The transmission and reception of a video in the prior art is accomplished over an Internet network or uses a mobile communication network provided by a mobile communication provider. If a mobile communication network is used, cost of communication increases, and if an Internet network is used, apparatuses used for transmission and reception of a video of a surveillance camera need to be restricted. That is, not all people should be allowed to access a specific surveillance camera.

To solve the various problems described above, a surveillance camera capable of outputting a video and a video transmission/reception system including the surveillance camera are needed.

### DISCLOSURE OF INVENTION

### Technical Problem

Therefore, the present invention has been made in view of the above problems, and it is an object of the present invention to provide a surveillance camera capable of outputting a video and a video transmission/reception system including the surveillance camera, which can transmit and receive a video between the surveillance camera and an external apparatus connected to an Internet network and display the received video on the surveillance camera.

In addition, another object of the present invention is to provide a surveillance camera capable of outputting a video and a video transmission/reception system including the surveillance camera, which can sense an abnormal situation occurring inside a home, such as an intrusion from the outside, and report the abnormal situation when the abnormal situation is sensed.

In addition, still another object of the present invention is to provide a surveillance camera capable of outputting a video and a video transmission/reception system including the surveillance camera, which can transmit a video taken by the surveillance camera to a plurality of external apparatuses so that several users may share the video received from the surveillance camera and display a video of a specific user on the surveillance camera.

In addition, still another object of the present invention is to provide a surveillance camera capable of outputting a video and a video transmission/reception system including the surveillance camera, which allow only restricted users to access the video of the surveillance camera.

The technical problems to be accomplished in the present invention are not limited to the technical problems described above, and unmentioned other technical problems may be clearly understood by those skilled in the art from the following descriptions.

### Technical Solution

To accomplish the above objects, according to one aspect of the present invention, there is provided a surveillance camera capable of outputting a video, the camera comprising: a communication unit for transmitting and receiving a network packet over an Internet network; a display unit for outputting the video generated on the basis of the received network packet; and a control unit for converting a data of the network packet into a video data to be output to the display unit.

In addition, the surveillance camera further comprises a sensing unit including one or more sensing sensors and outputting sensing signals of the sensing sensors, wherein the control unit creates a sensing data based on a sensing signal of a sensing sensor and outputs a network packet including the created sensing data to the communication unit.

In addition, the surveillance camera further comprises an image reception unit for capturing an image of an outside of the surveillance camera, and the control unit creates a video data from an image data captured by the image reception unit and outputs a network packet including the created video data to the communication unit.

In addition, a data of the network packet of the video data is a multicasting data directly transmitted to a plurality of external apparatuses over the Internet network, and the external apparatuses are surveillance cameras or portable terminals.

In addition, the communication unit of the surveillance camera receives a network packet from one external apparatus among the plurality of external apparatuses over the Internet network, and the control unit converts a data of the network packet received from the one external apparatus into a video data and outputs the video data to the display unit.

In addition, the control unit of the surveillance camera establishes communication channels to the plurality of external apparatuses permitted to connect to the surveillance camera using Web Real-Time Communication (WebRTC) framework, and as the communication channel to the one external apparatus is disconnected, the control unit converts a data of a network packet received from a subsequent external apparatus among the plurality of external apparatuses into a video data and outputs the video data to the display unit.

In addition, the communication unit of the surveillance camera receives a control data to be used for controlling the surveillance camera from the external apparatus as a network packet over the Internet network, and the control unit controls the image reception unit according to the received control data.

According to another aspect of the present invention, there is provided a video transmission/reception system comprising a surveillance camera, and the surveillance camera comprises: a communication unit for transmitting and receiving a network packet over an Internet network; a display unit for outputting a video generated on the basis of the received network packet; and a control unit for converting a data of the network packet into a video data to be output to the display unit.

In addition, the video transmission/reception system further comprises: a surveillance server connected to the surveillance camera; and an external apparatus capable of communicating with the surveillance camera, and the surveillance server intermediates establishment of a communication channel between the surveillance camera and the external apparatus, and after the communication channel is established, the surveillance camera directly receives a network packet from the external apparatus, and the received network packet is a video data or a control data for controlling the surveillance camera.

### Advantageous Effects

The surveillance camera capable of outputting a video and the video transmission/reception system including the surveillance camera according to the present invention as described above have an effect of transmitting and receiving a video between the surveillance camera and an external apparatus connected to an Internet network and displaying the received video on the surveillance camera.

In addition, the surveillance camera capable of outputting a video and the video transmission/reception system including the surveillance camera according to the present invention as described above have an effect of sensing an abnormal situation occurring inside a home, such as an intrusion from the outside, and reporting the abnormal situation when the abnormal situation is sensed.

In addition, the surveillance camera capable of outputting a video and the video transmission/reception system including the surveillance camera according to the present invention as described above have an effect of transmitting a video taken by the surveillance camera to a plurality of external apparatuses so that several users may share the video received from the surveillance camera and displaying a video of a specific user on the surveillance camera.

In addition, the surveillance camera capable of outputting a video and the video transmission/reception system including the surveillance camera according to the present invention as described above have an effect of allowing only restricted users to access the video of the surveillance camera.

The effects that can be obtained from the present invention are not limited to the effects described above, and unmentioned other effects may be clearly understood by those skilled in the art from the following descriptions.

### BRIEF DESCRIPTION OF DRAWINGS

FIG. 1 is a view showing an exemplary block diagram of a video transmission/reception system for transmitting and receiving a video.

FIG. 2 is a view showing an exemplary block diagram of a surveillance camera.

FIG. 3 is a view showing an exemplary process of transmitting and receiving a video between a surveillance camera and external apparatuses.

FIG. 4 is a view showing an exemplary process of controlling a surveillance camera by an external apparatus.

### DESCRIPTION OF REFERENCE NUMERALS

100: Surveillance camera

101: Input unit 103: Memory

105: Output unit 107: External interface unit

109: Sensing unit 111: Image reception unit

113: Display unit 115: Communication unit

117: Control unit 119: Connection unit

200: Surveillance server 300: External apparatus

### BEST MODE FOR CARRYING OUT THE INVENTION

The objects, features and advantages described will be further clarified from the following detailed descriptions, and accordingly, those skilled in the art may easily embody the technical spirits of the present invention. In addition, in describing the present invention, if specific description of already known functions related to the present invention may unnecessarily make the spirit of the present invention unclear, detailed description thereof will be omitted. The preferred embodiments of the present invention will be hereafter described in detail, with reference to the accompanying drawings.

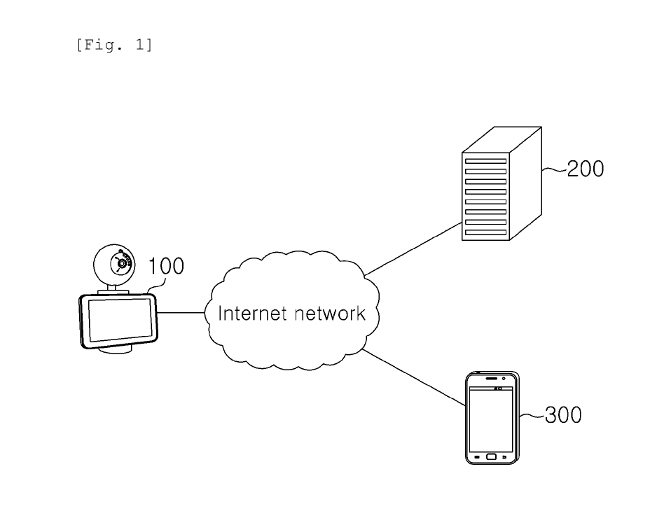

FIG. 1 is a view showing an exemplary block diagram of a video transmission/reception system for transmitting and receiving a video.

According to FIG. 1, a video transmission/reception system includes one or more surveillance cameras 100, a surveillance server 200 and one or more external apparatuses 300. In addition, the video transmission/reception system may further include another server connected to an Internet network. The video transmission/reception system may further include, for example, a server provided to determine a public Internet address.

Describing each of the apparatuses of the video transmission/reception system, the surveillance camera 100 is a camera installed in a specific space. The surveillance camera 100 is installed, for example, in a home, an office, a care facility in which a plurality of persons live together, or the like. The surveillance camera 100 is fixedly installed on a wall in a space or equipped on a table, a desk, a shelf or the like to be movable.

The surveillance camera 100 is provided with a display particularly such as a Liquid Crystal Display (LCD), a Light Emitting Diode (LED) or the like. The surveillance camera 100 captures an image of the outside of the surveillance camera 100 and creates a video data compressed from the captured image according to a predetermined format (e.g., H.264, MPEG2 or the like). The compressed video data may be transmitted to the outside over the Internet network. The compressed video data is transmitted to the surveillance server 200 or the external apparatus 300.

In addition, the surveillance camera 100 may receive a network packet containing the video data over the Internet network. The surveillance camera 100 may extract the payload of the received network packet and convert the payload into a video data that can be displayed on the display by decoding the payload in a predetermined format. The converted video data is output through the display. Like this, the surveillance camera 100 according to the present invention may perform video communication with the external apparatus 300 using the display.

In addition, the surveillance camera 100 may sense various type of intrusions from the outside and abnormal situations occurring in a space in which the surveillance camera 100 is installed and transmit a network packet containing a sensing data according thereto over the Internet network. The network packet of the sensing data is transferred to the surveillance server 200.

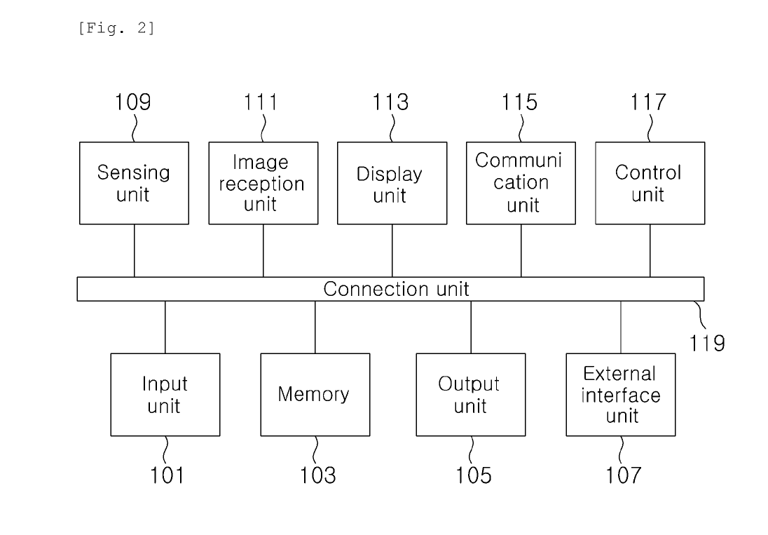

The surveillance camera 100 will be described in detail with reference to FIGS. 2 to 4.

The external apparatus 300 is an apparatus that can be connected to the surveillance server 200 and/or the surveillance camera 100 over the Internet network. The external apparatus 300 may be the surveillance camera 100 according to the present invention, or a portable terminal or a stationary terminal that can be connected to the Internet network. The portable terminal may be, for example, a cellular phone, a smart phone, a tablet PC or the like, and the stationary terminal may be a personal computer or a special purpose apparatus or the like. The special purpose apparatus may be designed to be connectable to the surveillance server 200.

The external apparatus 300 is configured to perform communication with the surveillance camera 100 through the mediation of the surveillance server 200. A plurality of specific external apparatuses 300 is mediated by the surveillance sever 200 to perform video communication with a specific surveillance camera 100. For example, the external apparatus 300 transmits a network packet containing a control data requesting video communication to the surveillance server 200. The surveillance server 200 may determine whether the external apparatus 300 is an apparatus capable of performing the video communication and mediate establishment of a communication channel between the external apparatus 300 and the surveillance camera 100 according to the determination. Thereafter, the external apparatus 300 and the surveillance camera 100 may directly transmit and receive network packets of compressed video data through the Internet network.

In addition, the external apparatus 300 is configured to control a specific surveillance camera 100 at a remote site through the mediation of the surveillance server 200. For example, the external apparatus 300 allowed to control the specific surveillance camera 100 may acquire a right to control the specific surveillance camera 100 by transmitting a network packet indicating a control request to the surveillance server 200 and directly control the surveillance camera 100 thereafter. Such a control request is defined in a format promised between the external apparatus 300 and the surveillance server 200, and a control data for controlling the surveillance camera 100 is also defined in a format promised between the surveillance camera 100 and the external apparatus 300. The control data may control one or more functions among several functions that can be controlled in the surveillance camera 100.

The surveillance server 200 is an apparatus capable of sensing an abnormal situation of the surveillance camera 100 and handling the sensed abnormal situation. The surveillance server 200 may be connected to a plurality of surveillance cameras 100 over the Internet network and receive network packets from the surveillance cameras 100. The received network packet is a packet containing, for example, a compressed video data, a sensing data or a control data requesting to perform a specific operation.

As the sensing data is received, the surveillance server 200 may inform a manager of reception of the sensing data through a display or an alarm. Accordingly, the manager of the surveillance server 200 may take a required action.

As the compressed video data is received, the surveillance server 200 may store the compressed video data into a storage medium inside the server and display the compressed video data on a specific display.

In addition, the surveillance server 200 may receive a network packet of a control data requesting to perform a specific operation from the surveillance camera 100 or the external apparatus 300. The received network packet may include, for example, a data defined according to the Web Real-Time Communication (WebRTC). The WebRTC provides a framework for a voice, a video and an execution of control, and the WebRTC may be mounted on the surveillance camera 100 or the external apparatus 300 in the form of software. The WebRTC is implemented on a web browser mounted on the surveillance camera 100 or the external apparatus 300.

The control data may indicate at least a video communication request from the surveillance camera 100 to a specific external apparatus 300, a video communication request from the external apparatus 300 to a specific surveillance camera 100, or a remote control request for controlling a specific surveillance camera 100 from the external apparatus 300. The surveillance server 200 may process a specific request using a so-called database. In response to the request, the surveillance server 200 mediates establishment of a communication channel between the surveillance camera 100 and the external apparatus 300. Such meditation includes permission or non-permission of connection and the like and includes various types of controls for establishing a direct communication channel between the surveillance camera 100 and the external apparatus 300. According to connection permission, the surveillance camera 100 may directly receive a network packet from the external apparatus 300 over the Internet network, convert (for example, decode) the compressed video data of the received network packet, and output the video data on the display. In addition, the surveillance camera 100 may receive a network packet from the external apparatus 300 over the Internet network, and operation of the surveillance camera 100 may be controlled according to the promised control data of the received network packet. Here, the network packet means a packet transmitted over a network on a layer higher than at least the Internet Protocol (IP) layer.

The database of the surveillance server 200 includes a plurality of entries related to each surveillance camera 100 and is configured to create, search and change the entries. An entry corresponds to a surveillance camera 100. The entry is configured to store data such as an identifier of the surveillance camera 100, a public Internet Protocol (IP) address of the surveillance camera 100, data of a plurality of external apparatuses that can be connected to the surveillance camera 100, an abnormal situation history, a history of actions taken when an abnormal situation occurs, a video communication history and the like.

Describing the fields of each entry in more detail, the identifier of the surveillance camera 100 is a data which can uniquely distinguish each of the surveillance cameras 100 managed by the surveillance server 200. The identifier may be, for example, a Media Access Control (MAC) address, promised numerals or characters or a combination of numeral(s) and character(s), a private (public) IP address or the like. Such an identifier is extracted from a network packet indicating a request, and various processes can be performed using the identifier.

The public IP address of the surveillance camera 100 is an Internet address accessible to the surveillance camera 100 over an Internet network. Since the surveillance camera 100 may be generally connected to the Internet network through a router, it needs to set a public IP address accessible in the Internet network. The public IP address is acquired through a TURN (Traversal Using Relay NAT) server (not shown) or a STUN (Session Traversal Utilities for NAT) server (not shown) used in the WebRTC. The public IP address is acquired from the surveillance camera 100 or from the STUN server as the surveillance camera 100 is connected to the STUN server. Like this, the public IP address is directly acquired by the surveillance server 200 or indirectly acquired by the surveillance camera 100. The public IP address may be changed in real-time according to connection of the surveillance camera 100 or as needed.

Data of the plurality of external apparatuses are data for identifying external apparatuses 300 connectable to the surveillance camera 100 and the right of the external apparatuses 300. The external apparatus data includes the public IP address of an external apparatus 300, identifier(s) of a surveillance camera 100 to which the external apparatus 300 may connect, a connection right of the external apparatus 300 and the like. The connection right shows whether the external apparatus 300 may perform video communication and, furthermore, remotely control the surveillance camera 100. The public IP address is also acquired through the TURN server, the STUN server and the like.

The abnormal situation history includes the sensing data received from the surveillance camera 100. The abnormal situation history includes at least the reception time of the sensing data, the sensing data, an abnormal situation type determined from the sensing data and the like. The history of actions taken when an abnormal situation occurs includes data showing an action taken for a specific sensing data. The video communication history includes an identifier of an external apparatus 300, a communication start time, a communication end time and the like so that the external apparatus 300 that has performed the video communication may be identified.

The surveillance server 200 connects the surveillance camera 100 and the external apparatus 300 using a database and allows the external apparatus 300 to perform video communication with the surveillance camera 100 and to control the surveillance camera 100. The surveillance server 200 preferably mediates connection of a communication channel between the external apparatus 300 and the surveillance camera 100 using a right or the like when the communication channel is established in response to a request. Thereafter, the external apparatus 300 and the surveillance camera 100 directly transmit and receive network packets, and the surveillance camera 100 or the external apparatus 300 displays received video data, or the surveillance camera 100 is controlled according to received control data.

Although it has been described that the surveillance server 200 uses a database, it does not to be limited thereto. For example, the surveillance server 200 may perform various controls using a data structure similar to the entry of the database.

The Internet network connected to the surveillance server 200, the external apparatus 300 and the surveillance camera 100 is configured to transmit and receive network packets conforming to the Internet Protocol (IP) according to the IP address.

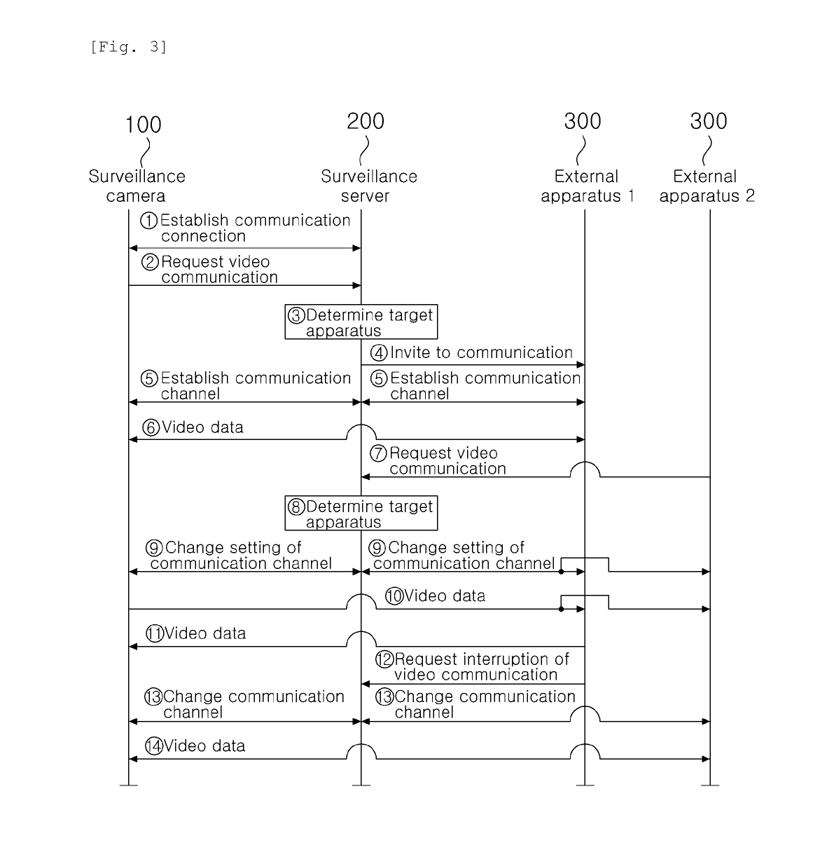

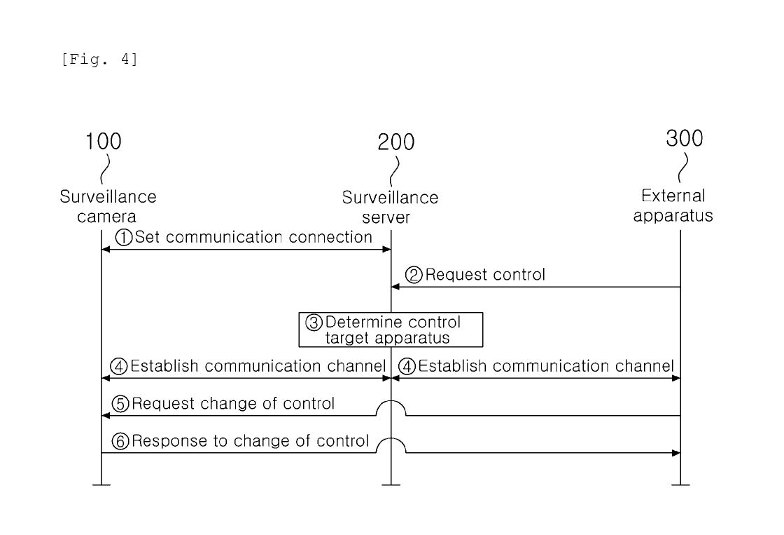

The process of handling the data using the surveillance server 200 will be described in more detail with reference to FIGS. 3 and 4.

FIG. 2 is a view showing an exemplary block diagram of a surveillance camera 100.

According to FIG. 2, the surveillance camera 100 includes an input unit 101, a memory 103, an output unit 105, an external interface unit 107, a sensing unit 109, an image reception unit 111, a display unit 113, a communication unit 115, a control unit 117 and a connection unit 119. Some of the blocks may be omitted according to modification of the configuration. Alternatively, other blocks may be further included in this block diagram.

Describing each of the blocks, the input unit 101 is configured to receive a user input using the surveillance camera 100. The input unit 101 includes, for example, a button, a touch panel or the like and may receive an input requesting connection of video communication to a specific external apparatus 300 from the user.

The input unit 101 may further include a microphone (MIC) and an Analog-Digital Converter (ADC) for voice signals. The input unit 101 transfers a voice signal received through the microphone to the control unit 117 through the ADC for voice signals.

The memory 103 stores various data and programs. The memory 103 includes, for example, volatile memory and/or non-volatile memory. The data and the program codes of the memory 103 may be accessed by the control unit 117.

The output unit 105 is provided with an LED, a buzzer, a speaker and the like and outputs data received from the control unit 117. The output unit 105 is used, for example, to inform an abnormal situation when the abnormal situation is sensed. Alternatively, the output unit 105 is used to output a voice data received from the external apparatus 300 during video communication with the external apparatus 300.

The external interface unit 107 is an interface for connecting to an external device. The external interface unit 107 may interface with a device connected to RS232, a Bluetooth device, a Universal Serial Bus (USB) device, a Secure Digital (SD) card and the like. A video data taken by the surveillance camera 100 may be stored in the external device connected through the external interface unit 107. The external interface unit 107 includes constitutional components needed according to the interface type. For example, if the external interface unit 107 is provided with a Bluetooth interface, the external interface unit 107 includes a wireless antenna used for Bluetooth and a modulation/demodulation unit for modulating and demodulating a base band signal.

The sensing unit 109 is provided with one or more sensing sensors and outputs a sensing signal detected by the sensing sensor. The sensing signal output from the sensing unit 109 is an analog or digital signal and is transferred to the control unit 117. The sensing unit 109 is configured to include an infrared sensor, a heat ray sensor, a magnetic sensor, an operation sensor and the like and output a sensing signal from a specific sensor.

The image reception unit 111 is provided with a camera lens and an image sensor. The image reception unit 111 focuses the image sensor on the outside of the surveillance camera 100 through the camera lens and may transfer an image captured by the image sensor to the control unit 117. The image sensor may be a Charge-Coupled Device (CCD) sensor, a Complementary Metal-Oxide Semiconductor (CMOS) sensor or the like.

In addition to the camera lens and the image sensor, the image reception unit 111 further includes a constitutional component for controlling the camera lens and the image sensor. Such a constitutional component performs, for example, a function for modifying an image captured through the camera lens and performs, for example, a function such as panning, tilting, zooming or the like. To perform a function such as panning, tilting, zooming or the like, the image reception unit 111 may be provided with, for example, a motor or the like and adjust a distance between the camera lens and the image sensor and a sensing region of the camera lens. The image reception unit 111 controls the constitutional component according to a control signal (data) received from the control unit 117.

The display unit 113 includes an LCD or LED display, receives a data signal containing an image from the control unit 117 and displays the data signal on the display. The display unit 113 is configured to output a video created by the control unit 117 and, furthermore, outputs an image for receiving a user input according to the type of the input unit 101. The display unit 113 may output the video created through the process of converting a network packet received over the Internet network.

The communication unit 115 transmits and receives network packets over the Internet network. The communication unit 115 includes an interface for connecting to a local area network such as an Ethernet or Wi-Fi. For example, the communication unit 115 may receive a packet on the MAC layer and transmit the received packet to the control unit 117, and receive a packet on the MAC layer from the control unit 117 and transmit the packet to the local area network. The communication unit 115 may transmit and receive a network packet of the IP layer or a layer higher than the IP layer by transmitting and receiving one or more packets on the MAC layer.

The control unit 117 controls the blocks of the surveillance camera 100. The control unit 117 includes an execution unit capable of executing program codes stored in the memory 103. For example, the control unit 117 is an execution unit referred to as a processor, a microcomputer, a Central Processing Unit (CPU), a Micro Processor Unit (MPU) or the like. The control unit 117 may further include a video codec configured in hardware logic.

The control unit 117 controls other blocks preferably using a program. Describing some processes executed in the control unit 117 and control operations according thereto, the control unit 117 establishes a communication connection with the surveillance server 200 at the time of booting the surveillance camera 100. To this end, the control unit 117 transmits and receives a request and a response for establishing the communication connection with the surveillance server 200 by way of the communication unit 115 and thus may establish a communication channel for transmitting and receiving data to and from the surveillance server 200.

In addition, the control unit 117 may control the communication unit 115 or the like to perform video communication with one or a plurality of external apparatuses 300. The control unit 117 may transmit a network packet of a data containing a video communication request and establish a communication channel to a specific external apparatus 300 in response thereto. Alternatively, the control unit 117 may receive a network packet of a data indicating a video communication request from the surveillance server 200 and establish a communication channel to one or more specific external apparatuses 300 in response thereto.

The control unit 117 receives a network packet through the communication unit 115. The control unit 117 reconfigures the received network packet as a network packet of a higher layer if required. The control unit 117 may identify a specific communication channel from the received network packet. If a network packet is received through the communication channel for video communication, the control unit 117 converts the payload data of the packet into a video data by decoding the payload data in a promised format. Thereafter, the control unit 117 outputs a series of image data of the converted video data to the display unit 113 according to an interface promised with the display unit 113.

The network packet including the video data is received from the external apparatus 300 through the established communication channel. The reconfigured packet may be, for example, a packet conforming to the Real-time Transport Protocol (RTP) implemented on the WebRTC framework.

In addition, the control unit 117 receives a sensing signal from the sensing unit 109 and creates a sensing data from the received sensing signal according to a format promised with the surveillance server 200. A network packet of the created sensing data is output through the communication channel (connection) established to the surveillance server 200 by way of the communication unit 115. In this process, the control unit 117 may determine whether the sensing signal indicates an abnormal situation. For example, if a sensing signal received from a specific sensing sensor is higher than an internally set threshold signal level, the control unit 117 may determine this as an abnormal situation such as an intrusion from the outside. Alternatively, if the sensing signal received from a specific sensing sensor is lower than an internally set threshold signal level, the control unit 117 may determine this as an abnormal situation. Furthermore, if a signal level of a voice signal of the input unit 101 is higher than a threshold level, the control unit 117 may determine this as an abnormal situation. An abnormal situation may be determined based on a security mode set according to a user input. According to the determination of the control unit 117, the control unit 117 may inform generation of an abnormal situation to the outside by controlling the output unit 105.

After establishing a communication channel of the external apparatus 300 or the surveillance server 200, the control unit 117 periodically receives image data from the image reception unit 111 and creates a compressed video data by encoding the image data in a predetermined format. In addition, the control unit 117 may receive a voice signal through the input unit 101, compress the received voice signal in a predetermined compress format and further include the compressed voice data in the video data.

The control unit 117 outputs the network packet including the created video data to the communication unit 115, and the communication unit 115 transmits the network packet over the Internet network. The network packet is transmitted to the surveillance server 200 and/or one or more of the external apparatuses 300 through the established communication channel. If the same video data is transmitted to a plurality of external apparatuses 300, the data of the network packet (e.g., data included in the payload of the network packet) is a multicasting data simultaneously transmitted to the plurality of external apparatuses 300. Accordingly, the control unit 117 may transmit a video to several external apparatuses 300 for which a communication channel is established by utilizing a single network packet. The external apparatus 300 may be a surveillance camera 100 according to the present invention or a portable terminal.

The control unit 117 may receive a compressed video data as a network packet from one of the plurality of external apparatuses 300 through a communication channel established through the mediation of the surveillance server 200 by way of the communication unit 115. The compressed video data of the received network packet is decoded in a promised format, and images of the video data converted as the network packet is decoded are sequentially output to the display unit 113.

All of the external apparatuses 300 connected for video communication are apparatuses permitted to connect to the surveillance camera 100 through the mediation of the surveillance server 200. The external apparatus 300 and the surveillance camera 100 are configured to establish a communication channel directly between the external apparatus 300 and the surveillance camera 100 using the WebRTC framework. Accordingly, after the initial mediation of the surveillance server 200, the external apparatus 300 and the surveillance camera 100 may perform video communication without control of the surveillance server 200. Furthermore, the external apparatus 300 and the surveillance camera 100 preferably do not use a mobile communication network provided by a mobile communication provider, but use a common Internet network.

A compressed video data is received from an external apparatus 300 among the external apparatuses 300. If the communication channel to the surveillance camera 100 is disconnected, a compressed video data is received from another external apparatus 300, and, thereafter, the video data of the another external apparatus 300 may be converted through decoding and output to the display unit 113.

The control unit 117 receives a network packet containing a control data from a specific permitted external apparatus 300 (furthermore, the surveillance server 200) through the established communication channel over the Internet network. The control unit 117 may identify the function of the received control data and control any one or more of the blocks of the surveillance camera 100 according to the identified function. For example, the control unit 117 receives a control data for controlling the function of the image reception unit 111 and outputs a control signal to the image reception unit 111 to perform a panning, tilting or zooming function according to the control data.

The flow of the process associated with the control unit 117 and accomplished over the Internet network will be described in more detail with reference to FIGS. 3 and 4.

The connection unit 119 makes it possible to transmit and receive data among the blocks. The connection unit 119 includes a parallel bus, a serial bus, a General Purpose Input Output (GPIO) or the like. The connection unit 119 may transmit and receive data or control data transferred between the blocks. The connection unit 119 is configured to accomplish transmission and reception of (control) data mainly through the control unit 117, and for example, the connection unit 119 may transmit and receive data to and from the memory 103 on the parallel bus and transmit an image signal to the display unit 113 according to a promised physical interface.

FIG. 3 is a view showing an exemplary process of transmitting and receiving a video between a surveillance camera 100 and external apparatuses 300. Although it is described in FIG. 3 that there are two external apparatuses 300, the same process may be performed for one external apparatus or three or more external apparatuses 300. Here, those described in FIGS. 1 and 2 will be omitted or briefly mentioned. Preferably, the process performed in the surveillance camera 100 is accomplished through the control unit 117, and the process may be performed by the control of the control unit 117 on the other blocks.

First, the surveillance camera 100 establishes a communication channel to establish a communication connection to the surveillance server 200 as the surveillance camera 100 is booted (see \textcircled{1} of FIG. 3). In the process of establishing the communication channel (hereinafter, also referred to as a ‘first communication channel’), the control unit 117 of the surveillance camera 100 determines its own public IP address through the STUN server or the like. The determined public IP address is transferred from the STUN server to the surveillance server 200 or from the surveillance camera 100 to the surveillance server 200. In addition, the surveillance camera 100 or the STUN server transfers the identifier of the surveillance camera 100 in the process of establishing the communication connection. Accordingly, the surveillance server 200 may identify an entry from the database using the identifier and change the public IP address in the entry.

The control unit 117 of the surveillance camera 100 receives a user input indicating a video communication request by way of the input unit 101 and transmits a packet indicating the video communication request for communicating with an external apparatus 300 corresponding to the received user input to the surveillance server 200 through the first communication channel (see \textcircled{2} of FIG. 3). Alternatively, after booting, the control unit 117 may transmit a packet indicating a video communication request for communicating with a predetermined external apparatus 300 to the surveillance server 200.

The surveillance server 200 determines a target external apparatus 300 from the video communication request received through the first communication channel (see \textcircled{3} of FIG. 3). The video communication request includes a data capable of identifying an external apparatus 300 according to a user input or identifying an automatically determined external apparatus 300. The surveillance server 200 may determine whether the external apparatus 300 requested to communicate with is a permitted apparatus based on the data of the plurality of external apparatuses of the surveillance camera 100 corresponding to the first communication channel using the data and transmit a response according to the determination to the surveillance camera 100. In this process, the right of the external apparatus 300 may also be used.

If the external apparatus 300 identified using the data is a permitted apparatus, the surveillance server 200 transmits a request indicating a communication invitation to the corresponding external apparatus 300 (see \textcircled{4} of FIG. 3). The public IP address of the external apparatus 300 may also be determined in advance through the STUN server or the like and stored in the surveillance server 200. Alternatively, the surveillance server 200 may determine the public IP address through the STUN server or the like when the communication invitation is requested.

The surveillance server 200 receives a response of the request for communication invitation from the external apparatus 300 and establishes a communication channel between the surveillance camera 100 and the external apparatus 300 according to the received response (see \textcircled{5} of FIG. 3). Establishing a communication channel includes, for example, exchange of Session Description Protocol (SDP) data according to the WebRTC. Exchange of the SDP data is accomplished through the first communication channel established between the surveillance server 200 and the surveillance camera 100 and the communication channel established between the surveillance server 200 and the external apparatus 300, and the surveillance server 200 may change corresponding data so that a communication channel may be established between the surveillance camera 100 and the external apparatus 300.

After the exchange of the SDP data, the surveillance camera 100 and the external apparatus 300 may determine various communication formats and the like and directly establish a specific communication channel (hereinafter, also referred to as a ‘second communication channel’). The second communication channel is preferably a communication channel that does not pass through the surveillance server 200.

Thereafter, the surveillance camera 100 transmits the compressed video data captured through a camera lens to the external apparatus 300 through the second communication channel, and the external apparatus 300 also transmits the compressed video data to the surveillance camera 100 through the second communication channel (see \textcircled{6} of FIG. 3).

Thereafter, another external apparatus 300 may attempt video communication with the same surveillance camera 100. Another external apparatus 300 transmits a video communication request to the surveillance server 200 through the communication channel (see \textcircled{7} of FIG. 3).

The surveillance server 200 determines a target apparatus as the video communication request is received (see \textcircled{8} of FIG. 3). The target apparatus may be the surveillance camera 100, and the surveillance server 200 identifies an entry from the database using the identifier of the surveillance camera 100 contained in the video communication request and confirms whether the requested external apparatus 300 exists in the data of a plurality of external apparatuses of the identified entry. If the external apparatus 300 exists, the surveillance server 200 determines whether the surveillance camera 100 of the identified entry is in a video communication. Such a determination may be accomplished by recording a data which indicates establishment of a communication channel, such as \textcircled{5} of FIG. 3, in the entry by the surveillance server 200 and recognizing the data.

If the communication channel has already been established, the surveillance server 200 may transmit a channel change request for changing the currently established second communication channel to the surveillance camera 100 and the existing external apparatus 300 through the first communication channel or the like (see \textcircled{9} of FIG. 3). In addition, the surveillance server 200 may transmit a data for informing the changed communication channel to other external apparatuses 300.

Data of the channel change request makes it possible to multicast at least the video data created and compressed by the surveillance camera 100 to all external apparatuses 300 to which the video communication has been requested.

Thereafter, the surveillance camera 100 transmits the compressed video data to a plurality of external apparatuses 300 through the changed second communication channel (see \textcircled{10} of FIG. 3), and the plurality of external apparatuses 300 may decode and display the compressed video data on the display.

An external apparatus 300 first connected to the surveillance camera 100 also transmits the compressed video data through the second communication channel (see \textcircled{11} of FIG. 3), and the surveillance camera 100 may display an image of the received video data through the display unit 113.

Through the process as described above, several external apparatuses 300 may receive and display video data from the same surveillance camera 100. In addition, the surveillance camera 100 may receive and display video data from a single external apparatus 300. Apparently, if several external apparatuses 300 are connected to a single surveillance camera 100 over an Internet network, the surveillance server 200 may grant a priority to a specific external apparatus 300. For example, it may be configured such that when a specific external apparatus 300 is connected to the surveillance camera 100 according to the right of each external apparatus 300, video data from the external apparatus 300 is transferred to the surveillance camera 100. The priority is included in the entry of the database and preferably included in the data of a plurality of external apparatuses.

Thereafter, an external apparatus 300 transmits a packet indicating a request for interrupting the video communication to the surveillance server 200 (see \textcircled{12} of FIG. 3), and the surveillance server 200 may identify a surveillance camera 100 and transmit a communication channel change request to the surveillance camera 100 and another external apparatus 300 to change the second communication channel established for the surveillance camera 100 (see \textcircled{13} of FIG. 3). Such a communication channel change request induces creation of a packet for a single external apparatus 300 rather than creation of a multicast data.

Thereafter, the surveillance camera 100 and the external apparatus 300 still connected to each other may transmit and receive packets of compressed video data each other.

The external apparatus 300 and the surveillance camera 100 may establish connection of a communication channel using the WebRTC framework, and transmit and receive video data.

Through the process as described above, the surveillance camera 100 may perform video communication with several external apparatuses 300 having a right and perform communication with several external apparatuses 300 while utilizing the limited performance of the control unit 117 of the surveillance camera 100.

FIG. 4 is a view showing an exemplary processing procedure for controlling a surveillance camera 100 by an external apparatus 300. In FIG. 4, it is described assuming that one external apparatus 300 may control one surveillance camera 100. In FIG. 4, it will be described briefly as far as not to be overlapped with the description of FIGS. 2 and 3.

First, the surveillance camera 100 is connected to the surveillance server 200 and establishes a communication connection of the first communication channel (see \textcircled{1} of FIG. 4).

Thereafter, a specific external apparatus 300 transmits a control request requesting control of a specific surveillance camera 100 to the surveillance server 200 (see \textcircled{2} of FIG. 4).

As the control request is received, the surveillance server 200 identifies a database entry using the identifier of the surveillance camera 100 included in the control request and determines a surveillance camera 100, which is a control target apparatus (see \textcircled{3} of FIG. 4). The surveillance server 200 searches for the identifier of the external apparatus 300 included in the control request from the entry and determines whether a corresponding external apparatus 300 that has requested the control exists and, furthermore, whether the external apparatus 300 has a right to control the surveillance camera 100. The surveillance server 200 may transmit a response according to the determination to the external apparatus 300.

If the external apparatus 300 that has requested the control exists in the identified entry and has a right, the surveillance server 200 establishes a communication channel between the surveillance camera 100 and the external apparatus 300 (see \textcircled{4} of FIG. 4). Establishing a communication channel includes exchange of information of WebSocket. After exchanging the WebSocket each other, the surveillance camera 100 and the external apparatus 300 may establish a new communication channel.

Thereafter, the external apparatus 300 directly transmits a control change request for changing a control performed in the surveillance camera 100 to the surveillance camera 100 through the newly established communication channel (see \textcircled{5} of FIG. 4). The control change request includes a control data such as a control message, and the surveillance camera 100 controls the blocks according to the received control message. For example, the control message may be a data indicating change of the panning, tilting or zooming function that the image reception unit 111 may perform. Accordingly, the control unit 117 of the surveillance camera 100 may perform a corresponding function by controlling the image reception unit 111 according to the data indicating change of the panning, tilting or zooming function.

The WebSocket may be configured on a web browser and may be configured in the WebRTC framework.

Thereafter, the surveillance camera 100 transmits a response of the control change request to the external apparatus 300 (see \textcircled{6} of FIG. 4).

Through the process as shown in FIG. 4, the surveillance camera 100 allows controls through an Internet network. In addition, only the external apparatuses 300 permitted by the surveillance server 200 may perform a corresponding control.

Since those skilled in the art may make various substitutions, modifications and changes without departing from the scope and spirit of the present invention, the present invention described above is not limited by the embodiments described above and the accompanying drawings.

1-9. (canceled)

10. A surveillance camera capable of outputting a video, the camera comprising:
a communication unit for transmitting and receiving a network packet over an Internet network;
a display unit for outputting a video generated on the basis of the received network packet; and
a control unit for establishing a first communication channel to a surveillance server through the communication unit, transmitting a network packet indicating a request for video communication to the surveillance server through the communication unit over the first communication channel, and establishing a second communication channel capable of directly communicating with a first external apparatus corresponding to the request for video communication over the Internet network through mediation of the surveillance server,
wherein the control unit converts a data of the network packet directly received from the first external apparatus through the second communication channel into a video data to be output to the display unit.

11. The camera according to claim 10, further comprising:
a sensing unit including one or more sensing sensors and outputting sensing signals of the sensing sensors,
wherein the control unit creates a sensing data based on a sensing signal of a sensing sensor and outputs a network packet including the created sensing data to the communication unit through the first communication channel.

12. The camera according to claim 10, wherein the control unit determines a public IP address of the surveillance camera in the process of establishing the first communication channel using a Session Traversal Utilities for NAT (STUN) server connected to the Internet network and performs exchange of Session Description Protocol (SDP) data according to Web Real-Time Communication (WebRTC) through the first communication channel in the process of establishing the second communication channel.

13. The camera according to claim 10, further comprising:
an image reception unit for capturing an image of an outside of the surveillance camera,
wherein the control unit receives a network packet indicating a channel change request for transmitting an additional video to a second external apparatus, from the surveillance server through the first communication channel, and changes the second communication channel in response to the channel change request, and
the control unit creates a video data from a captured image data and transmits a network packet of the created video data through the changed second communication channel as a multicasting data directly transmitted to the first external apparatus and the second external apparatus.

14. The camera according to claim 13, wherein the communication unit receives a network packet from one external apparatus among the first external apparatuses and the second external apparatuses through the second communication channel over the Internet network according to a priority granted by the surveillance server, and
the control unit converts a data of the network packet received from the one external apparatus into a video data and outputs the video data to the display unit.

15. The camera according to claim 14, wherein the control unit establishes the second communication channel to the first external apparatus and the second external apparatus permitted to connect to the surveillance camera, using a WebRTC framework implemented on a web browser mounted on the control unit, and
as communication connection with the one external apparatus is disconnected, the control unit converts a data of a network packet received from an external apparatus connected to the second communication channel and different from the one external apparatus into a video data and outputs the video data to the display unit.

16. The camera according to claim 10, further comprising an image reception unit for capturing an image of an outside the surveillance camera,
wherein the communication unit receives a control data to be used for controlling the surveillance camera from the external apparatus as a network packet over the Internet network, and
the control unit controls the image reception unit according to the received control data.

17. A video transmission/reception system including the surveillance camera according to claim 10.

18. The system according to claim 17, further comprising:
a surveillance server connected to the surveillance camera through a first communication channel; and
an external apparatus capable of communicating with the surveillance camera through a second communication channel,
wherein the surveillance server intermediates establishment of the second communication channel between the surveillance camera and the external apparatus, and
after the second communication channel is established, the surveillance camera directly receives a network packet from the external apparatus through the second communication channel, and the received network packet is a video data or a control data for controlling the surveillance camera.
